(19) United States
(12) Patent Application Publication
(10) Pub. No.: US 2013/0095420 A1
(43) Pub. Date: Apr. 18, 2013

(54) ELECTROPHOTOGRAPHIC TONER

(71) Applicant: Shiho Moriya, Shizuoka (JP)

(72) Inventor: Shiho Moriya, Shizuoka (JP)

(73) Assignees: TOSHIBA TEC KABUSHIKI KAISHA, Tokyo (JP); KABUSHIKI KAISHA TOSHIBA, Tokyo (JP)

(21) Appl. No.: 13/625,122

(22) Filed: Sep. 24, 2012

Related U.S. Application Data
(60) Provisional application No. 61/546,118, filed on Oct. 12, 2011.
(60) Provisional application No. 61/602,681, filed on Feb. 24, 2012.

(51) Int. Cl. G03G 9/087; G03G 9/09; B82Y 30/00

(52) U.S. Cl. 430/107.1; 430/109.4; 977/773

(57) ABSTRACT

An electrophotographic toner according to an embodiment includes toner particles, which contain a coloring material containing C.I. Pigment Red 48 and C.I. Pigment Red 122 at a weight ratio of from 30:70 to 80:20, a binder resin containing an amorphous polyester resin and a crystalline polyester resin, a wax, and a charge control agent, and which have a glass transition point (Tg) of from 30 to 45° C. and an acid value of from 10 to 17 mgKOH/g.

### CROSS-REFERENCE TO RELATED APPLICATION

This application is based upon and claims the benefit of priority from provisional U.S. Patent Application 61/546,118 filed on Oct. 12, 2011, and 61/602,681 filed on Feb. 24, 2012, the entire contents of which are incorporated herein by reference.

### TECHNICAL FIELD

Embodiments described herein relate to an electrophotographic toner which has excellent low-temperature fixability and color reproducibility, and also has excellent manufacturability in kneading and pulverization.

### BACKGROUND

An electrophotographic process is known as a process for forming a visible image by developing an electrostatic latent image with a color toner. In this process, generally, an electrostatic latent image is formed on a photoconductive photoconductor, color toners of yellow, magenta, cyan, etc. are sequentially attached thereto to form toner images, and the respective toner images are transferred onto a transfer medium in an overlapping manner, and the toner images are fixed by pressing and heating, whereby a visible image is obtained.

A toner to be used in the above process is required to have wide range color reproducibility so as to accurately reproduce the colors of a scanned image, and also to have excellent light resistance so as not to cause color fading in a visible image, etc. Further, in recent years, a toner is required to have low-temperature fixability due to the trend of energy saving in consideration of environment.

In light of this, as a toner having excellent color reproducibility, light resistance, etc., for example, a toner in which an azo lake pigment and a quinacridone pigment are used in combination in a coloring material and the glass transition point (Tg) of a binder resin and the like are specified is known. However, this toner has disadvantages that the low-temperature fixability, charging stability, and coloring power are not sufficient. Further, in order to obtain favorable color reproducibility, a flushing treatment of a coloring material or a master batch prepared by kneading with a high shearing force at a high concentration is needed, etc., and the number of production steps is increased, and therefore, the production cost of such a toner is increased.

### BRIEF DESCRIPTION OF THE DRAWINGS

The accompanying drawing which is incorporated in and constitute a part of this specification, illustrates an embodiment of the invention and together with the description, serve to explain the principles of the invention.

FIG. 1 is a schematic structural view of an electrophotographic apparatus according to an embodiment.

### DETAILED DESCRIPTION

Reference will now be made in detail to the present embodiment of the invention, an example of which is illustrated in the accompanying drawing.

An electrophotographic magenta toner of the present embodiment includes toner particles, which contain a coloring material containing C.I. Pigment Red 48 and C.I. Pigment Red 122 at a weight ratio of from 30:70 to 80:20, a binder resin containing an amorphous polyester resin and a crystalline polyester resin, a wax, and a charge control agent, and which have a glass transition point (Tg) of from 30 to 45° C. and an acid value of from 10 to 17 mgKOH/g.

Further, a developer of the present embodiment is an electrophotographic developer including at least a yellow toner, a cyan toner, and a magenta toner, wherein the magenta toner includes toner particles, which contain a coloring material containing C.I. Pigment Red 48 and C.I. Pigment Red 122 at a weight ratio of from 30:70 to 80:20, a binder resin containing an amorphous polyester resin and a crystalline polyester resin, a wax, and a charge control agent, and which have a glass transition point (Tg) of from 30 to 45° C. and an acid value of from 10 to 17 mgKOH/g.

Further, an electrophotographic apparatus of the present embodiment is a full-color electrophotographic apparatus provided with an image carrier on which an image to be transferred onto a transfer medium is formed by supplying a yellow toner, a cyan toner, and a magenta toner to an electrostatic latent image, thereby developing the electrostatic latent image, wherein the magenta toner includes toner particles, which contain a coloring material containing C.I. Pigment Red 48 and C.I. Pigment Red 122 at a weight ratio of from 30:70 to 80:20, a binder resin containing an amorphous polyester resin and a crystalline polyester resin, a wax, and a charge control agent, and which have a glass transition point (Tg) of from 30 to 45° C. and an acid value of from 10 to 17 mgKOH/g.

According to the present embodiment, a toner which has excellent low-temperature fixability, charging stability, and color reproducibility, and also has excellent manufacturability in kneading and pulverization can be provided.

In general, C.I. Pigment Red 48, which is an azo lake pigment, has favorable color formability and a high coloring power, but exhibits a color strongly tinged with red and has low light resistance. On the other hand, C.I. Pigment Red 122, which is a quinacridone pigment, has high chroma and high light resistance, but exhibits a color strongly tinged with blue and has a low coloring power. In view of this, in the present embodiment, by allowing C.I. Pigment Red 48 and C.I. Pigment Red 122 to coexist with each other, and setting the ratio (weight ratio) of the content of C.I. Pigment Red 48 to the content of C.I. Pigment Red 122 to 30:70 to 80:20, a color hue can be controlled to fall within an appropriate range while maintaining the coloring power and light resistance.

On the other hand, when the glass transition point (Tg) of the toner is merely set in a range of from 30 to 45° C., although the low-temperature fixability is enhanced, the viscosity when kneading is liable to be low, and therefore, the dispersibility of the coloring material to be blended becomes poor and the coloring power is decreased. In view of this, in the present embodiment, by incorporating a crystalline polyester resin and also setting the acid value of the toner to 10 to 17 mgKOH/g, the dispersibility of C.I. Pigment Red 48 and C.I. Pigment Red 122 can be enhanced even if the glass transition point (Tg) of the toner is in the above-described range, and the performance of these two pigments is sufficiently exhibited and a toner having a high coloring power can be formed. Accordingly, it is possible to obtain a toner having favorable color reproducibility without performing a complicated step required for achieving favorable color reproducibility such as a flushing treatment or preparation of a master batch by kneading with a high shearing force at a high concentration in the production of a toner by the kneading and pulverization method.

Moreover, due to the effects of the crystalline polyester resin and the acid value of the toner, the deposition of the pigments on the surfaces of the toner particles is suppressed and the charging stability is improved, and therefore, a high-quality image can be achieved over a long period of time.

Hereinafter, the present embodiment will be more specifically described.

In the present embodiment, as the coloring material to be used in the magenta toner, C.I. Pigment Red 48 and C.I. Pigment Red 122 are blended at a content ratio (weight ratio) of from 30:70 to 80:20. If the content ratio of C.I. Pigment Red 48 is less than 30% by weight, sufficient light resistance cannot be obtained, and also the blue tinge becomes stronger, and therefore, the color reproducible range of a red color to be reproduced by the superposition with a yellow toner is reduced. On the other hand, if the content ratio of C.I. Pigment Red 48 exceeds 80% by weight, a sufficient coloring power cannot be obtained, and also the red tinge becomes stronger, and therefore, the color reproducible range of a blue color to be reproduced by the superposition with a cyan toner is reduced.

As the binder resin to be used in the present embodiment, a polyester resin can be used. The polyester resin can be produced with reference to the process described in, for example, JP-A-7-175260 using a dihydric or higher hydric alcohol component and a divalent or higher valent carboxylic acid component such as a carboxylic acid, a carboxylic acid anhydride, or a carboxylic acid ester.

Specific examples of the dihydric alcohol component include alkylene oxide adducts of bisphenol A such as
polyoxypropylene(2.2)-2,2-bis(4-hydroxyphenyl)propane,
polyoxypropylene(3.3)-2,2-bis(4-hydroxyphenyl)propane,
polyoxyethylene(2.0)-2,2-bis(4-hydroxyphenyl)propane,
polyoxypropylene(2.0)-polyoxyethylene(2.0)-2,2-bis(4-hydroxyphenyl)propane, and
polyoxypropylene(6)-2,2-bis(4-hydroxyphenyl)propane,
ethylene glycol, diethylene glycol, triethylene glycol,
1,2-propylene glycol, 1,3-propylene glycol,
1,4-butanediol, neopentyl glycol, 1,4-butenediol,
1,5-pentanediol, 1,6-hexanediol,
1,4-cyclohexanedimethanol, dipropylene glycol,
polyethylene glycol, polypropylene glycol,
polytetramethylene glycol, bisphenol A, and hydrogenated bisphenol A.

Examples of the trihydric or higher hydric alcohol component include sorbitol, 1,2,3,6-hexanetetrol, 1,4-sorbitan, pentaerythritol, dipentaerythritol, tripentaerythritol, 1,2,4-butanetriol, 1,2,5-pentanetriol, glycerol, 2-methylpropanetriol, 2-methyl-1,2,4-butanetriol, trimethylolethane, trimethylolpropane, and 1,3,5-trihydroxymethylbenzene.

Among these dihydric alcohols and trihydric or higher hydric alcohols, one alcohol can be used alone or a plurality of alcohols can be used in combination. In particular, it is preferred to use, as a main component, a bisphenol A alkylene (carbon number: 2 or 3) oxide adduct (average addition molar number: 1 to 10), ethylene glycol, propylene glycol, 1,6-hexanediol, bisphenol A, hydrogenated bisphenol A, sorbitol, 1,4-sorbitan, pentaerythritol, glycerol, or trimethylolpropane.

Examples of the divalent carboxylic acid component include maleic acid, fumaric acid, citraconic acid, itaconic acid, glutaconic acid, phthalic acid, isophthalic acid, terephthalic acid, cyclohexanedicarboxylic acid, succinic acid, adipic acid, sebacic acid, azelaic acid, malonic acid, alkenylsuccinic acids such as n-dodecenylsuccinic acid, alkylsuccinic acids such as n-dodecylsuccinic acid, and acid anhydrides or lower alkyl esters thereof.

Examples of the trivalent or higher valent carboxylic acid component include
1,2,4-benzenetricarboxylic acid (trimellitic acid),
2,5,7-naphthalenetricarboxylic acid,
1,2,4-naphthalenetricarboxylic acid,
1,2,4-butanetricarboxylic acid,
1,2,5-hexanetricarboxylic acid,
1,3-dicarboxyl-2-methyl-2-methylenecarboxypropane,
1,2,4-cyclohexanetricarboxylic acid,
tetra(methylenecarboxyl)methane,
1,2,7,8-octanetetracarboxylic acid, pyromellitic acid, enpol trimer acid, and acid anhydrides or lower alkyl esters thereof.

Among these divalent carboxylic acids and trivalent or higher valent carboxylic acids, one carboxylic acid can be used alone or a plurality of carboxylic acids can be used in combination. In particular, it is preferred to use, as a main component, maleic acid, fumaric acid, terephthalic acid, or succinic acid substituted by an alkenyl group having 2 to 20 carbon atoms, each of which is a divalent carboxylic acid component, 1,2,4-benzenetricarboxylic acid (trimellitic acid), which is a trivalent or higher valent carboxylic acid component, or an acid anhydride or alkyl (carbon number: 1 to 12) ester thereof, or the like.

When polymerizing the above-described alcohol component and carboxylic acid component, in order to accelerate the reaction, a commonly used catalyst such as dibutyltin oxide, a titanium compound, a dialkoxytin(II), tin(II) oxide, a fatty acid tin(II), tin(II) dioctanoate, or tin(II) distearate may be appropriately used.

As the binder resin, it is preferred to incorporate a crystalline polyester resin. By incorporating the crystalline polyester resin, the glass transition point (Tg) of the toner particles can be decreased, and therefore, the toner has favorable low-temperature fixability. Further, the crystalline polyester resin has excellent dispersibility and high affinity for C.I. Pigment Red 122. Accordingly, by blending the crystalline polyester resin, the dispersibility of C.I. Pigment Red 122 is enhanced.

Examples of the acid component of the crystalline polyester resin include adipic acid, oxalic acid, malonic acid, maleic acid, fumaric acid, citraconic acid, itaconic acid, glutaconic acid, succinic acid, phthalic acid, isophthalic acid, terephthalic acid, sebacic acid, azelaic acid, n-dodecylsuccinic acid, n-dodecenylsuccinic acid, cyclohexanedicarboxylic acid, trimellitic acid, pyromellitic acid, and acid anhydrides or alkyl (carbon number: 1 to 3) esters thereof. Among these, fumaric acid is preferred. Examples of the alcohol component include ethylene glycol, 1,2-propylene glycol, 1,3-propylene glycol, 1,4-butanediol, 1,5-pentanediol, 1,6-hexanediol, neopentyl glycol, 1,4-butenediol, polyoxypropylene, polyoxyethylene, glycerin, pentaerythritol, and trimethylolpropane. Among these, 1,4-butanediol or 1,6-hexanediol is preferred.

The blending amount of the crystalline polyester resin is preferably from 5 to 13 parts by weight in the toner particles. If the blending amount is less than 5 parts by weight, the low-temperature fixability is not sufficient and also the contribution to the enhancement of the dispersibility of C.I. Pigment Red 122 in the toner particles is decreased. If the blending amount is larger than 13 parts by weight, the Tg is decreased too much and the pulverizability or storage stability is deteriorated.

Incidentally, as the crystalline polyester resin in the present embodiment, a polyester resin having a ratio of the softening point to the melting temperature (softening point/melting temperature) of from 0.9 to 1.1 is used.

The glass transition point (Tg) of the toner of the present embodiment is preferably in a range of from 30 to 45° C. By setting the glass transition point (Tg) in the above range, the low-temperature fixability and pulverizability are enhanced. If the glass transition point (Tg) is lower than 30° C., the pulverizability or storage stability is deteriorated. On the other hand, if the glass transition point (Tg) is higher than 45° C., the low-temperature fixability is deteriorated.

Further, it is necessary to set the acid value of the toner of the present embodiment to 10 to 17 mgKOH/g. By setting the acid value of the toner in the above range, the dispersibility of C.I. Pigment Red 48 in the toner particles can be enhanced. If the acid value of the toner is less than 10 mgKOH/g, the effect of improving the dispersibility of the coloring material cannot be obtained. On the other hand, if the acid value of the toner exceeds 17 mgKOH/g, the chargeability in a high temperature and high humidity environment is decreased.

The acid value of the toner varies depending on the acid values of the constituent materials of the toner particles, such as a binder resin and a wax, and depends particularly on the acid value of the binder resin which accounts for the majority of the percentage of the constituent materials. Therefore, as a method for adjusting the acid value of the toner, for example, by blending a binder resin having an acid value within the above-described range, or by blending a plurality of binder resins having different acid values, the acid value can be adjusted to fall within the above range.

As the wax to be used in the present embodiment, an ester-based wax having favorable compatibility with the polyester resin to be used in the binder resin is preferably used. As the ester-based wax, a natural ester wax and a synthetic ester wax can be used. Examples of the natural ester wax include candelilla wax, carnauba wax, and rice wax. As the synthetic ester wax, a wax synthesized from a long-chain alkyl carboxylic acid component and a long-chain alkyl alcohol component can be used. The blending amount of the wax is not particularly limited, but is preferably from 3 to 17 parts by weight with respect to 100 parts by weight of the binder resin.

As the charge control agent, for example, a metal-containing azo compound is used. As the metal-containing azo compound, a metal complex or a metal complex salt in which the metal element is selected from iron, cobalt, and chromium, or a mixture thereof can be exemplified. Further, a metal-containing salicylic acid derivative compound or a metal oxide subjected to a hydrophobization treatment is also used, and for example, a metal complex or a metal complex salt in which the metal element is selected from zirconium, zinc, and chromium, or a mixture thereof, and a complex or a complex salt of such a metal with boron, or a mixture thereof, and a clathrate compound of a polysaccharide containing aluminum and magnesium can be exemplified. Among these, a clathrate compound of a polysaccharide containing aluminum and magnesium is preferred. The blending amount of the charge control agent can be set to 0.5 to 2 parts by weight with respect to 100 parts by weight of the binder resin.

The toner particles of the present embodiment are preferably produced by a kneading and pulverization process. The toner particles of the present embodiment can achieve favorable color reproducibility without resort to a complicated step such as a flushing treatment or preparation of a master batch by kneading with a high shearing force at a high concentration in the production by the kneading and pulverization process, and therefore, the production cost of the toner can be suppressed.

As for the production of the toner particles of the present embodiment, specifically, the above-described materials are mixed by a dry process, and the resulting mixture is melt-kneaded, and pulverized and classified, whereby the toner particles are produced. As for a device for mixing and dispersing these materials, for example, as a mixing machine, Henschel Mixer (manufactured by Mitsui Mining Co., Ltd.); Super Mixer (manufactured by Kawata MFG Co., Ltd.); Ribocorn (manufactured by Okawara Corporation); Nauta Mixer, Turbulizer, and Cyclomix Mixer (all of which are manufactured by Hosokawa Micron Corporation); Spiralpin Mixer (manufactured by Pacific Machinery & Engineering Co., Ltd.); and Lodige Mixer (manufactured by Matsubo Corporation) can be exemplified. As a kneading machine, a KRC kneader (manufactured by Kurimoto, Ltd.); Buss Ko-Kneader (manufactured by Buss AG); a TEM type extruder (manufactured by Toshiba Machine Co., Ltd.); a TEX twin-screw kneading machine (manufactured by The Japan Steel Works, Ltd.); a PCM kneading machine (manufactured by Ikegai, Ltd.); a three-roll mill, a mixing roll mill, and a kneader (all of which are manufactured by Inoue Mfg., Inc.); Kneadex (manufactured by Mitsui Mining Co., Ltd.); an MS type pressure kneader and a kneader-ruder (both of which are manufactured by Moriyama Company Ltd.); and Banbury mixer (manufactured by Kobe Steel, Ltd.) can be exemplified.

As a device for coarsely pulverizing the mixture, for example, a hammer mill, a cutter mill, a jet mill, a roller mill, a ball mill, etc. can be exemplified. Also, as a pulverizer to be used as a device for finely pulverizing the coarsely pulverized material, for example, a counter jet mill, Micron jet and Inomizer (all of which are manufactured by Hosokawa Micron Corporation); an IDS type mill and a PJM jet pulverizer (both of which are manufactured by Nippon Pneumatic Mfg. Co., Ltd.); Cross jet Mill (manufactured by Kurimoto, Ltd.); Ulmax (manufactured by Nisso Engineering Co., Ltd.); SK Jet-O-Mill (manufactured by Seisin Enterprise Co., Ltd.); Cliptron (manufactured by Kawasaki Heavy Industries, Ltd.); and Turbo Mill (manufactured by Turbo Kogyo Co., Ltd.) can be exemplified.

Also, as a classifying machine for classifying the finely pulverized material, for example, Classiel, Micron Classifier and Spedic Classifier (all of which are manufactured by Seisin Enterprises Co., Ltd.); Turbo Classifier (manufactured by Nisshin Engineering Co., Ltd.); Micron Separator, Turboplex (ATP), and TSP Separator (all of which are manufactured by Hosokawa Micron Corporation); Elbow-Jet (manufactured by Nittetsu Mining Co., Ltd.); Dispersion Separator (manufactured by Nippon Pneumatic Mfg. Co., Ltd.); and YM Microcut (manufactured by Yasukawa Shoji K.K.) can be exemplified.

In order to stabilize the fluidity, chargeability and storage stability of the toner particles obtained through the above-described mixing, dispersion, pulverization, classification, etc., fine particles of an external additive can be added to the surfaces of the toner particles. As the fine particles of an external additive, for example, inorganic oxide fine particles of silica, titania, alumina, strontium titanate, tin oxide, or the like can be exemplified. As the fine particles of an external additive, it is preferred that at least two or more types of inorganic oxide fine particles having different average primary particle diameters are mixed and added. Specifically, it is preferred that inorganic oxide fine particles having an average primary particle diameter of less than 80 nm and inorganic oxide fine particles having an average primary particle diameter of from 80 to 200 nm are added. By adding the fine particles of an external additive having such particle diameters, the obtained charging property can be maintained. As such inorganic oxide fine particles, it is preferred to use those surface-treated with a hydrophobizing agent from the viewpoint of improvement of environmental stability. Further, other than such inorganic oxide fine particles, resin fine particles having an average particle diameter of 1 μm or less can be further added.

As for the addition amount of the fine particles of an external additive, the fine particles of an external additive can be added in an amount of from 2 to 10 parts by weight with respect to 100 parts by weight of the toner particles. As a device for mixing such fine particles of an external additive, the above-described mixing machines are used.

As a sieving device to be used for sieving out coarse particles and the like, Ultra Sonic (manufactured by Koei Sangyo Co., Ltd.); Resona Sieve and Gyro sifter (both of which are manufactured by Tokuju Corporation); Vibrasonic System (manufactured by Dalton Co., Ltd.); Soniclean (manufactured by Shinto Kogyo Kabushiki Kaisha); Turbo screener (manufactured by Turbo Kogyo Co., Ltd.); Micro sifter (manufactured by Makino Mfg. Co., Ltd.); a circular vibrating sieve; and the like can be exemplified.

Further, in the present embodiment, the toner particles may be prepared by the following process.

A coarsely granulated mixture containing at least the binder resin and the coloring material is mixed with an aqueous medium, whereby a mixed liquid is obtained. The obtained mixed liquid is subjected to mechanical shearing, whereby the coarsely granulated mixture is finely granulated. The thus obtained fine particles are aggregated to form aggregated particles, whereby toner particles are obtained. If necessary, after forming the aggregated particles, a step of fusing the aggregated particles to one another may be performed.

In the present embodiment, among the toners constituting the developer, the respective toners other than the magenta toner such as a yellow toner, a cyan toner, and a black toner are not particularly limited as long as they can be fixed to a transfer medium under the same temperature condition as that for the magenta toner. For example, in such a toner, the coloring material is changed to a coloring material corresponding to each toner, and the above-described materials can be used. In such a case, as the coloring material to be used therein, for example, a carbon black, an organic or inorganic pigment or dye, or the like, which is used in a color toner, can be used. Examples of the carbon black include acetylene black, furnace black, thermal black, channel black, and ketjen black. Further, examples of the pigment or dye include Fast Yellow G, Benzidine Yellow, Indo Fast Orange, Irgazin Red, Carmine FB, Permanent Bordeaux FRR, Pigment Orange R, Lithol Red 2G, Lake Red C, Rhodamine FB, Rhodamine B Lake, Phthalocyanine Blue, Pigment Blue, Brilliant Green B, Phthalocyanine Green, and quinacridone. These coloring materials can be used alone or in admixture according to a color.

Such a developer is used for, for example, an image forming apparatus as described below.

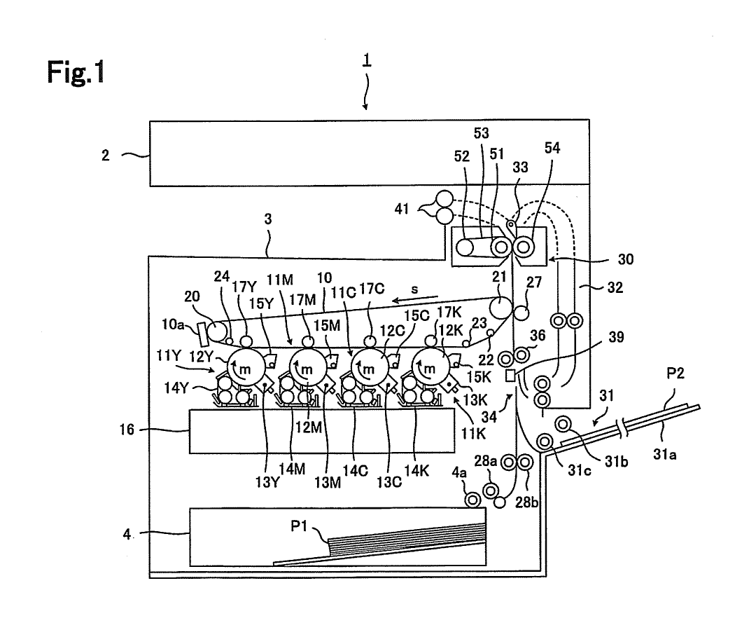

FIG. 1 is a schematic view showing an exemplary electrophotographic apparatus to which the developer of the present embodiment can be applied.

As shown in FIG. 1, a scanner section 2 and a paper discharge section 3 are provided in an upper portion of a color copier, MFP (Multi Function Peripheral) 1 of a quadruple tandem system.

The color copier 1 has image forming stations 11Y, 11M, 11C and 11K of four groups of yellow (Y), magenta (M), cyan (C) and black (K) disposed in parallel along a lower side of an intermediate transfer belt (intermediate transfer medium) 10.

The respective image forming stations 11Y, 11M, 11C and 11K have photoreceptor drums (image carriers) 12Y, 12M, 12C and 12K, respectively. In the surroundings of the photoreceptor drums 12Y, 12M, 12C and 12K, electrification chargers 13Y, 13M, 13C and 13K; development apparatuses 14Y, 14M, 14C and 14K; and photoreceptor cleaning apparatuses 15Y, 15M, 15C and 15K are disposed along the rotation direction shown by an arrow m direction.

On the way from the electrification chargers 13Y, 13M, 13C and 13K to the development apparatuses 14Y, 14M, 14C and 14K in the surroundings of the photoreceptor drums 12Y, 12M, 12C and 12K, laser light is applied by a laser exposure apparatus (latent image forming apparatus) 16, an electrostatic latent image is formed on the photoreceptor drums 12Y, 12M, 12C and 12K.

Each of the development apparatuses 14Y, 14M, 14C and 14K has a two-component developing agent composed of each of yellow (Y), magenta (M), cyan (C) and black (K) toners and a carrier, respectively and feeds the toner to the electrostatic latent image on the photoreceptor drums 12Y, 12M, 12C and 12K, respectively.

The intermediate transfer belt 10 is hung by a backup roller 21, a driven roller 20 and first to third tension rollers 22 to 24. The intermediate transfer belt 10 is opposed to and brought into contact with the photoreceptor drums 12Y, 12M, 12C and 12K. Primary transfer rollers 17Y, 17M, 17C and 17K for primarily transferring the toner images on the photoreceptor drums 12Y, 12M, 12C and 12K onto the intermediate transfer belt 10 are provided at positions of the intermediate transfer belt 10 opposing the photoreceptor drums 12Y, 12M, 12C and 12K, respectively. Each of these primary transfer rollers 17Y, 17M, 17C and 17K is a conductive roller, and a primary transfer bias voltage is impressed in each of these primary transfer sections.

A secondary roller 27 is disposed in a secondary transfer section which is a transfer position of the intermediate transfer belt 10 supported by the backup roller 21. In the secondary transfer section, the backup roller 21 is a conductive roller, and a prescribed secondary transfer bias is impressed thereto. When a sheet paper (a final transfer medium) which is an object to printing passes between the intermediate transfer belt 10 and the secondary transfer roller 27, the toner image on the intermediate transfer belt 10 is secondarily transferred onto the sheet paper. After completion of the secondary transfer, the intermediate transfer belt 10 is cleaned up by a belt cleaner 10a.

A paper feed cassette 4 for feeding a sheet paper P1 toward the direction of the secondary transfer roller 27 is provided in a lower portion of the laser exposure apparatus 16. A manual-bypass mechanism 31 for manually feeding a sheet paper P2 is provided on the right side of the color copier 1. On the way from the paper feed cassette 4 to the secondary transfer roller 27, a pickup roller 4a, a separation roller 28a, a carrying roller 28b and a resist roller pair 36 are provided, thereby constituting a paper feed mechanism.

On the way from a manual-bypass tray 31a of the manual-bypass mechanism 31 to the resist roller pair 36, a manual-bypass pickup roller 31b and a manual-bypass separation roller 31c are provided. Furthermore, a medium sensor 39 for detecting the kind of sheet paper is disposed on a vertical carrying route 34 for carrying the sheet paper from the paper feed cassette 4 or the manual-bypass tray 31a toward the direction of the secondary transfer roller 27. The color copier 1 is able to control a carrying rate of sheet paper, a transfer condition, a fixing condition and so on from the detection results by the medium sensor 39. Also, a fuser units 30 is provided in the downstream of the secondary transfer section along the direction of the vertical carrying route 34. The sheet paper taken out from the paper feed cassette 4 or fed from the manual-bypass mechanism 31 is carried into the fuser units 30 through the resist roller pair 36 and the secondary transfer roller 27 along the vertical carrying route 34.

The fuser units 30 has a fuser units 53 wound around a pair of a heating roller 51 and a driving roller 52 and a counter roller 54 disposed opposing the heating roller 51 via the fuser units 53. The sheet paper having a toner image transferred in the secondary transfer section is introduced between the fuser units 53 and the counter roller 54, and the toner image transferred onto the sheet paper is heat treated and fixed upon heating by the heating roller 51. A gate 33 is provided in the downstream of the fuser units 30, whereby the sheet paper is distributed into the direction of a paper discharge roller 41 and the direction of a recarrying unit 32. The sheet paper introduced into the paper discharge roller 41 is discharged into the paper discharge section 3. Also, the sheet paper introduced into the recarrying unit 32 is again introduced onto the direction of the secondary transfer roller 27.

The image forming station 11Y has the photoreceptor drum 12Y and a process measure in an integral manner and is provided in a detachable manner relative to a main body of the image forming apparatus. The process measure as referred to herein means at least one of the electrification charger 13Y, the development apparatus 14Y and the photoreceptor cleaning apparatus 15Y. Each of the image forming stations 11M, 11C and 11K has the same configuration as the image forming station 11Y. Each of the image forming stations 11Y, 11M, 11C and 11K may be detachable relative to the image forming apparatus or may be detachable as the integrated image forming unit 11 relative to the image forming apparatus.

Hereinafter, the present embodiment will be more specifically described by showing Examples.

### [1] Preparation of Magenta Toner

### EXAMPLE 1

| | | |
|---|---|---|
| Pigment: | 6 | parts by weight |
| (C.I. Pigment Red 48.3: | 3 | parts by weight) |
| (C.I. Pigment Red 122: | 3 | parts by weight) |
| Binder resin: | 90 | parts by weight |
| (Amorphous polyester resin: | 80 | parts by weight) |
| (Crystalline polyester resin: | 10 | parts by weight) |
| Ester wax (melting point: 70° C.): | 3 | parts by weight |
| Charge control agent (polysaccharide | 1 | part by weight |
| compound containing Al and Mg): | | |

The above-described materials were mixed by Henschel Mixer, and the resulting mixture was melt-kneaded by a twin-screw extruder, and the resulting melt-kneaded material was cooled.

The melt-kneaded material after cooling was coarsely pulverized by a hammer mill, followed by finely pulverization with a jet pulverizing machine and classification, whereby toner particles having a volume average particle diameter of 7 μm were obtained.

Incidentally, as the amorphous polyester resin, a resin obtained by blending a resin B (acid value: 19.4 mgKOH/g) and a resin D (acid value: 11.3 mgKOH/g) at a weight ratio of 50:50 was used.

To 100 parts by weight of the thus obtained toner particles, the following additives were added and mixed by Henschel Mixer, whereby toner particles in which the additives were added to the surfaces of the particles were prepared.

### Additives:

Monodispersed inorganic fine particle compound having an average primary particle diameter of 100 nm, hydrophobic silica: 1 part by weight

Hydrophobic silica having an average primary particle diameter of 30 nm: 1 part by weight

Hydrophobic titanium oxide having an average primary particle diameter of 20 nm: 0.5 parts by weight

The obtained toner particles were mixed with a silicone resin-surface coated ferrite carrier having an average particle diameter of 40 μm in an amount of 7 parts by weight with respect to 100 parts by weight of the ferrite carrier by stirring in a tabular mixer, thereby obtaining a magenta toner.

### EXAMPLES 2 TO 17 AND COMPARATIVE EXAMPLES 1 TO 16

Magenta toners in which as the pigment and the binder resin, components shown in Table 1 were contained at a blending ratio as shown in Table 1 were obtained in the same manner as in Example 1.

Incidentally, the Tg (glass transition point) of the toner was measured by the following method.

By using a differential scanning calorimeter (DSC) “DSC Q2000” (manufactured by TA Instruments, Inc.), the measurement was carried out under the following conditions: sample: 5 mg, lid and pan: alumina, temperature raising rate: 10° C./min, and measurement temperature: 20 to 200° C. A data was obtained by the measurement when the sample was heated to 200° C., followed by cooling the sample to 20° C. or lower and again heating the sample. Tangents on the low temperature side and the high temperature side of a curve generated at from around 30° C. to 60° C. were drawn, and a point of intersection of extension lines thereof was defined as Tg.

Further, the acid value of the toner was measured according to JIS K 0070.

### [2] Evaluation of Quality Properties

The following evaluation was performed for the respective toners of Examples 1 to 17 and Comparative Examples 1 to 16. The evaluation results are shown in Table 1.

Evaluation items:

### Pulverizability

By using a counter et mill and 100 TTSP (manufactured by Hosokawa Micron Corporation), pulverization and classification were performed. The classification was performed such that the target particle diameter of the volume 50% particle measured using Coulter Multisizer III was set to 7 μm and the percentage of the particles having a diameter of 3.17 μm (number %) or less was set to 10% or less. A case where the yield after the classification was 70% or more was evaluated as “Good” and a case where the yield after the classification was less than 70% was evaluated as “Bad”.

### Storage Stability

15 g of each toner was placed in a plastic container, and the container was hermetically sealed and left for 10 hours in a thermostat bath set at a temperature of 55° C. Then, the container was taken out from the thermostat bath and the toner was naturally cooled for 12 hours or more. Thereafter, the cooled toner was placed on a 42-mesh sieve and vibrated at a scale of 4 for 10 seconds using a powder tester (manufactured by Hosokawa Micron Corporation). A case where the residual amount of the toner on the sieve was less than 3 g was evaluated as “Good” and a case where the residual amount of the toner on the sieve was 3 g or more was evaluated as “Bad”.

### Low-Temperature Fixability

By using a multifunction peripheral e-STUDIO 4520C manufactured by Toshiba Tec Corporation, a solid image was printed at a temperature of 130° C. on 10 sheets of paper. A case where the image was not even slightly peeled off due to offset or non-fixation was evaluated as “Good”, and a case where the image was peeled off was evaluated as “Bad”.

### Color Reproducible Range

By using a multifunction peripheral e-STUDIO 4520C manufactured by Toshiba Tec Corporation, a solid image was obtained such that a toner deposition amount on a sheet was around 0.45 mg/cm². The obtained solid image was measured using a spectrodensitometer X-Rite 938 (manufactured by X-Rite Co., Ltd.), and a case where the value of b* of the L*a*b* color specification system was from −10 to 15 was evaluated as “Good”, and a case where the value of b* of the L*a*b* color specification system was less than −10 and more than 15 was evaluated as “Bad”. If the value of b* is less than −10, the color reproducible range of a red color is reduced, and if the value of b* is more than 15, the color reproducible range of a blue color is reduced.

### Light Resistance

By using a multifunction peripheral e-STUDIO 4520C manufactured by Toshiba Tec Corporation, a solid image was obtained such that an image density as measured using Macbeth 19I was 0.7. The obtained solid image was irradiated with light at an illumination of 550 W/m² for 100 hours with Sun Test CPS+ (manufactured by Atlas Co., Ltd.). An image density retention after the irradiation with light as compared with the image density before irradiation with light was calculated, and a case where the image density retention was 90% or more was evaluated as “Good”, and a case where the image density retention was less than 90% was evaluated as “Bad”.

### Coloring Power

By using a multifunction peripheral e-STUDIO 4520C manufactured by Toshiba Tec Corporation, a solid image was obtained such that a toner deposition amount on a sheet was around 0.45 mg/cm². The obtained solid image was measured using Macbeth 19I, and a case where the measurement value was 1.4 or more was evaluated as “Good”, and a case where the measurement value was less than 1.4 was evaluated as “Bad”.

### Long-Life Property (Image Density)

By using a multifunction peripheral e-STUDIO 4520C manufactured by Toshiba Tec Corporation, printing was performed at a coverage of 8% on 150000 sheets of paper in a test environment in which the temperature was adjusted to 20 to 25° C. and the humidity was adjusted to 40 to 60%. Thereafter, a solid image was obtained. The obtained solid image was measured using Macbeth 19I, and a case where the measurement value was 1.3 or more was evaluated as “Good”, and a case where the measurement value was less than 1.3 was evaluated as “Bad”.

TABLE 1

| | | | | Amorphous | | | | | | |
|---|---|---|---|---|---|---|---|---|---|---|
| | | | | polyester resin | | | | Crystalline | | Acid value of |
| | Pigment | | | | | | Content | polyester resin | Tg of | toner |
| | Type*¹ | | Ratio | Type*² | | Ratio | [wt %] | Content [wt %] | toner [° C.] | [mgKOH/g] |
| Example 1 | P.R.48:3 | P.R.122 | 50:50 | B | D | 50:50 | 80 | 10 | 37 | 15 |
| Example 2 | P.R.48:3 | P.R.122 | 50:50 | B | E | 50:50 | 77 | 13 | 31 | 14 |
| Example 3 | P.R.48:3 | P.R.122 | 50:50 | C | D | 50:50 | 77 | 13 | 31 | 11 |
| Example 4 | P.R.48:3 | P.R.122 | 50:50 | B | F | 50:50 | 85 | 5 | 43 | 12 |
| Example 5 | P.R.48:3 | P.R.122 | 50:50 | A | F | 50:50 | 77 | 13 | 30 | 17 |
| Example 6 | P.R.48:3 | P.R.122 | 50:50 | C | E | 50:50 | 85 | 5 | 44 | 10 |
| Example 7 | P.R.48:3 | P.R.122 | 50:50 | A | F | 50:50 | 85 | 5 | 45 | 17 |
| Example 8 | P.R.48:3 | P.R.122 | 30:70 | A | F | 50:50 | 77 | 13 | 31 | 17 |
| Example 9 | P.R.48:3 | P.R.122 | 30:70 | B | D | 50:50 | 85 | 5 | 45 | 16 |
| Example 10 | P.R.48:3 | P.R.122 | 30:70 | B | F | 50:50 | 80 | 10 | 37 | 12 |
| Example 11 | P.R.48:3 | P.R.122 | 80:20 | C | D | 50:50 | 77 | 13 | 31 | 11 |
| Example 12 | P.R.48:3 | P.R.122 | 80:20 | C | E | 50:50 | 85 | 5 | 45 | 10 |
| Example 13 | P.R.48:3 | P.R.122 | 80:20 | B | F | 50:50 | 80 | 10 | 37 | 12 |
| Example 14 | P.R.48:2 | P.R.122 | 50:50 | B | E | 50:50 | 80 | 10 | 36 | 14 |
| Example 15 | P.R.48:2 | P.R.122 | 30:70 | B | F | 50:50 | 80 | 10 | 37 | 12 |
| Example 16 | P.R.48:2 | P.R.122 | 30:70 | B | D | 50:50 | 80 | 10 | 36 | 15 |
| Example 17 | P.R.48:2 | P.R.122 | 40:60 | B | F | 50:50 | 80 | 10 | 37 | 12 |
| Comparative Example 1 | P.R.48:3 | P.R.122 | 0:100 | C | F | 50:50 | 90 | 0 | 47 | 9 |
| Comparative Example 2 | P.R.48:3 | P.R.122 | 20:80 | C | E | 50:50 | 90 | 0 | 44 | 10 |
| Comparative Example 3 | P.R.48:3 | P.R.122 | 20:80 | B | F | 50:50 | 77 | 13 | 32 | 12 |
| Comparative Example 4 | P.R.48:3 | P.R.122 | 20:80 | A | E | 50:50 | 80 | 10 | 36 | 18 |
| Comparative Example 5 | P.R.48:3 | P.R.122 | 90:10 | B | E | 50:50 | 90 | 0 | 43 | 14 |
| Comparative Example 6 | P.R.48:3 | P.R.122 | 90:10 | B | D | 50:50 | 80 | 10 | 37 | 15 |
| Comparative Example 7 | P.R.48:3 | P.R.122 | 90:10 | B | F | 50:50 | 75 | 15 | 29 | 13 |
| Comparative Example 8 | P.R.48:3 | P.R.122 | 90:10 | B | F | 50:50 | 80 | 10 | 36 | 12 |
| Comparative Example 9 | P.R.48:3 | P.R.122 | 50:50 | B | E | 50:50 | 90 | 0 | 42 | 14 |
| Comparative Example 10 | P.R.48:3 | P.R.122 | 50:50 | C | F | 50:50 | 90 | 0 | 43 | 8 |
| Comparative Example 11 | P.R.48:3 | P.R.122 | 50:50 | B | F | 50:50 | 90 | 0 | 46 | 12 |
| Comparative Example 12 | P.R.48:3 | P.R.122 | 50:50 | A | E | 50:50 | 77 | 13 | 33 | 18 |
| Comparative Example 13 | P.R.48:3 | P.R.122 | 50:50 | C | F | 50:50 | 80 | 10 | 37 | 9 |
| Comparative Example 14 | P.R.48:3 | P.R.122 | 50:50 | C | E | 50:50 | 75 | 15 | 29 | 9 |
| Comparative Example 15 | P.R.48:3 | P.R.122 | 50:50 | B | F | 50:50 | 75 | 15 | 29 | 12 |
| Comparative Example 16 | P.R.48:3 | P.R.122 | 50:50 | A | D | 50:50 | 75 | 15 | 29 | 19 |

| | | | | | | | Long-life |
|---|---|---|---|---|---|---|---|
| | | Storage | Low-temperature | Color | Light | Coloring | property |
| | Pulverizability | stability | fixability | reproducibility | resistance | power | (image density) |
| Example 1 | Good | Good | Good | Good | Good | Good | Good |
| Example 2 | Good | Good | Good | Good | Good | Good | Good |
| Example 3 | Good | Good | Good | Good | Good | Good | Good |
| Example 4 | Good | Good | Good | Good | Good | Good | Good |
| Example 5 | Good | Good | Good | Good | Good | Good | Good |
| Example 6 | Good | Good | Good | Good | Good | Good | Good |
| Example 7 | Good | Good | Good | Good | Good | Good | Good |
| Example 8 | Good | Good | Good | Good | Good | Good | Good |
| Example 9 | Good | Good | Good | Good | Good | Good | Good |
| Example 10 | Good | Good | Good | Good | Good | Good | Good |
| Example 11 | Good | Good | Good | Good | Good | Good | Good |
| Example 12 | Good | Good | Good | Good | Good | Good | Good |
| Example 13 | Good | Good | Good | Good | Good | Good | Good |
| Example 14 | Good | Good | Good | Good | Good | Good | Good |
| Example 15 | Good | Good | Good | Good | Good | Good | Good |
| Example 16 | Good | Good | Good | Good | Good | Good | Good |
| Example 17 | Good | Good | Good | Good | Good | Good | Good |
| Comparative Example 1 | Good | Good | Bad | Bad | Good | Bad | Good |
| Comparative Example 2 | Good | Good | Bad | Bad | Good | Bad | Good |
| Comparative Example 3 | Good | Good | Good | Bad | Good | Bad | Good |
| Comparative Example 4 | Good | Good | Good | Bad | Good | Bad | Bad |
| Comparative Example 5 | Good | Good | Bad | Bad | Bad | Good | Good |
| Comparative Example 6 | Good | Good | Good | Bad | Bad | Good | Good |
| Comparative Example 7 | Bad | Bad | Good | Bad | Bad | Good | Good |
| Comparative Example 8 | Good | Good | Good | Bad | Bad | Good | Good |
| Comparative Example 9 | Good | Good | Bad | Good | Good | Good | Good |
| Comparative Example 10 | Good | Good | Bad | Good | Good | Good | Bad |
| Comparative Example 11 | Good | Good | Bad | Good | Good | Good | Good |
| Comparative Example 12 | Good | Good | Good | Good | Good | Good | Bad |
| Comparative Example 13 | Good | Good | Good | Good | Good | Good | Bad |
| Comparative Example 14 | Bad | Bad | Good | Bad | Good | Bad | Good |
| Comparative Example 15 | Bad | Bad | Good | Good | Good | Good | Good |
| Comparative Example 16 | Bad | Bad | Good | Good | Good | Good | Bad |

*¹P.R. = Pigment Red
*²Acid value of resin (mgKOH/g); A = 28.8, B = 19.4, C = 12.6, D = 11.3, E = 8.1, F = 4.8

In the case of the toners of the present embodiments, favorable results were obtained in the evaluation of each of the properties of pulverizability, storage stability, low-temperature fixability, color reproducible range, light resistance, coloring power, and long-life property.

On the other hand, when the ratio of the pigment was outside the range of the present embodiment, the color reproducible range was reduced, and moreover, when the blending ratio of C.I. Pigment Red 48 was low, the coloring power was low, and when the blending ratio of C.I. Pigment Red 122 was low, the light resistance was not sufficient. Further, when the crystalline polyester resin was not contained, the low-temperature fixability tended to be deteriorated, and when the Tg of the toner was low, the storage stability was poor and also the pulverizability was poor. Further, when the acid value of the toner was outside the range of the present embodiment, the long-life property tended to be deteriorated.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions the accompanying claims and their equivalents are intended to cover such forms or modifications as would fall within the scope and spirit of the inventions.

What is claimed is:

1. An electrophotographic toner comprising toner particles
containing a coloring material containing C.I. Pigment Red 48 and C.I. Pigment Red 122 at a weight ratio of from 30:70 to 80:20, a binder resin containing an amorphous polyester resin and a crystalline polyester resin, a wax, and a charge control agent, and
having a glass transition point (Tg) of from 30 to 45° C. and an acid value of from 10 to 17 mgKOH/g.

2. The toner according to claim 1, wherein the crystalline polyester resin is contained in an amount of from 5 to 13% by weight in the toner particles.

3. The toner according to claim 1, wherein fine particles of an external additive are added to the surfaces of the toner particles.

4. The toner according to claim 3, wherein the fine particles of an external additive are inorganic oxide fine particles having an average primary particle diameter of from 80 to 200 nm.

5. The toner according to claim 4, wherein inorganic oxide fine particles having an average primary particle diameter of less than 80 nm are further added to the surfaces of the toner particles.

6. An electrophotographic developer comprising at least a yellow toner, a cyan toner, and a magenta toner,
the magenta toner including toner particles
containing a coloring material containing C.I. Pigment Red 48 and C.I. Pigment Red 122 at a weight ratio of from 30:70 to 80:20, a binder resin containing an amorphous polyester resin and a crystalline polyester resin, a wax, and a charge control agent, and
having a glass transition point (Tg) of from 30 to 45° C. and an acid value of from 10 to 17 mgKOH/g.

7. The developer according to claim 6, wherein the crystalline polyester resin is contained in an amount of from 5 to 13% by weight in the toner particles.

8. The developer according to claim 6, wherein fine particles of an external additive are added to the surfaces of the toner particles.

9. The developer according to claim 8, wherein the fine particles of an external additive are inorganic oxide fine particles having an average primary particle diameter of from 80 to 200 nm.

10. The developer according to claim 9, wherein inorganic oxide fine particles having an average primary particle diameter of less than 80 nm are further added to the surfaces of the toner particles.
